(19) United States
(12) Patent Application Publication
(10) Pub. No.: US 2026/0204842 A1
(43) Pub. Date: Jul. 16, 2026

(54) FEMALE CONNECTOR AND CONNECTOR DEVICE

(71) Applicant: Shanghai Kangsuo Auto Electric Technical co. ltd, Shanghai (CN)

(72) Inventors: Yizhao SUN, Shanghai (CN); Xiang ZHANG, Shanghai (CN)

(73) Assignee: Shanghai Kangsuo Auto Electric Technical co. ltd, Shanghai (CN)

(21) Appl. No.: 19/447,680

(22) Filed: Jan. 13, 2026

(30) Foreign Application Priority Data
Jan. 16, 2025 (CN) 202520099152.5

(51) Int. Cl. H01R 13/631; H01R 13/639

(52) U.S. Cl. CPC H01R 13/631; H01R 13/639

(57) ABSTRACT

Provided are a female connector and a connector device. The female connector can mate with a male connector, and the male connector includes a male connector body and multiple male terminals. The male connector body is formed with a slot, and the multiple male terminals are spaced apart and are erected at the bottom of the slot. The female connector includes a female connector body and an anti-misalignment plate. The female connector body can mate with the slot and is provided with female ports. The anti-misalignment plate is mounted at one end of the female connector body adjacent to the male connector and is formed with first guide grooves. A male terminal can be inserted into a corresponding female port. A sidewall of the first guide groove is gradually tilted outward from one end adjacent to the female connector body toward the other end to form a first guide angle.

### CROSS-REFERENCE TO RELATED APPLICATION

This application claims priority to Chinese Patent Application No. 202520099152.5, filed with the China National Intellectual Property Administration (CNIPA) on Jan. 16, 2025, the disclosure of which is incorporated herein by reference in its entirety.

### TECHNICAL FIELD

The present application relates to the technical field of electrical devices and, in particular, to a female connector and a connector device.

### BACKGROUND

At present, a connector device is typically adopted for connections between a wire harness and a wire harness and between a wire harness and an electrical component, which is an essential component for interconnecting various electrical and electronic devices. The connector device typically includes a female connector and a male connector, and the female connector is electrically connected to the male connector through the mating between the female connector and the male connector. The male connector is provided with male terminals densely arranged, and correspondingly, the female connector is provided with female ports densely arranged. The male connector is electrically connected to the female connector by inserting the male terminals into the female ports in one-to-one correspondence.

The male terminals are generally slender and needle-shaped structures that protrude a certain height from the assembly plane of the male connector. These male terminals are prone to tilting or misalignment, which may prevent normal insertion into the female ports. During insertion, the male terminals are prone to deformation, causing the connector device to malfunction and requiring the repair of the male connector. Tilted or misaligned male terminals are commonly referred to as "tilted needles."

An existing connector device typically includes an anti-misalignment plate provided on the male connector. The anti-misalignment plate is provided with positioning openings that are in one-to-one correspondence with the male terminals. Before the female connector is inserted into the male connector, the male terminals first mate with the positioning openings, and the anti-misalignment plate is located at an upper mid-portion of the male terminals to secure the male terminals to prevent the male terminals from being tilted. This requires all the male terminals to be correctly oriented before the male terminals mate with the positioning openings. Moreover, during insertion, meticulous alignment is required to prevent interference of the anti-misalignment plate from causing the male terminals to be tilted. This assembly process is time-consuming and labor-intensive, and requires the male connector to be designed in a structure compatible with the anti-misalignment plate, making it unsuitable for existing male connectors already in use.

Therefore, a female connector and a connector device are urgently needed to solve the preceding problems.

### SUMMARY

An object of the present application is to provide a female connector and a connector device, so as to prevent male terminals from being tilted, improve the success rate of mating and assembly efficiency between the female connector and a male connector, reduce the maintenance rate of the male connector, and ensure compatibility with existing male connectors.

To achieve the object, the present application adopts the technical solutions below.

A female connector is provided. The female connector is configured to mate with a male connector, where the male connector includes a male connector body and multiple male terminals, the male connector body is formed with a slot, and the multiple male terminals are spaced apart and are erected at a bottom of the slot; and where the female connector includes a female connector body and an anti-misalignment plate, the female connector body is configured to mate with the slot, and the female connector body is provided with multiple female ports that are in one-to-one correspondence with the multiple male terminals; the anti-misalignment plate is mounted at one end of the female connector body adjacent to the male connector, and the anti-misalignment plate is formed with multiple first guide grooves that are in one-to-one correspondence with the multiple female ports, and among the multiple male terminals, the multiple first guide grooves, and the multiple female ports, a male terminal is insertable into a corresponding female port through a corresponding first guide groove.

A sidewall of the first guide groove is gradually tilted outward from one end adjacent to the female connector body toward the other end.

Further, a sidewall of one end of the first guide groove adjacent to the female connector body extends along a height direction of the first guide groove to form a first receiving groove.

Further, the anti-misalignment plate is snap-fitted to the female connector body.

Further, two ends of the female connector body along a length direction of the female connector body and/or two sides of the female connector body along a width direction of the female connector body are provided with snap blocks, respectively, the anti-misalignment plate is provided with snaps that are in one-to-one correspondence with the snap blocks, and the snaps are configured to snap-fit with the snap blocks, respectively.

Further, the anti-misalignment plate is provided with limiting portions, and when the anti-misalignment plate is snap-fitted to the female connector body, the female connector body is clamped between the limiting portions.

Further, among the snap blocks, a lower end of a snap block is provided with a guide surface, and the guide surface is gradually tilted upward in a direction away from the female connector body.

Further, the female connector body is formed with snap-receiving grooves that are in one-to-one correspondence with the snap blocks, the snap blocks are disposed within the snap-receiving grooves, respectively, and the snap-receiving grooves are configured to accommodate the snaps, respectively.

Further, the female port includes a second receiving groove and a second guide groove, the second guide groove communicates with one end of the second receiving groove adjacent to the anti-misalignment plate, and a sidewall of the second guide groove is gradually tilted outward from one end adjacent to the second receiving groove toward the other end.

Further, a sidewall of one end of the second guide groove adjacent to the second receiving groove extends along a height direction of the second guide groove to form a third receiving groove, and the third receiving groove communicates with the second guide groove and the second receiving groove.

A connector device is provided. The connector device includes a male connector and the preceding female connector, where the male connector includes the male connector body and the multiple male terminals, the male connector body is formed with the slot, and the multiple male terminals are spaced apart and are erected at the bottom of the slot; the female connector body is configured to mate with the slot, and among the multiple male terminals, the multiple first guide grooves, and the multiple female ports, the male terminal is insertable into the corresponding female port through the corresponding first guide groove.

The present application has the beneficial effects below.

The present application provides the female connector and the connector device. The female connector can mate with the male connector, and the male connector includes the male connector body and the multiple male terminals. The male connector body is formed with the slot, and the multiple male terminals are spaced apart and are erected at the bottom of the slot. The female connector includes the female connector body and the anti-misalignment plate. The female connector body can mate with the slot and is provided with the female ports that are in one-to-one correspondence with the male terminals. The anti-misalignment plate is mounted at the end of the female connector body adjacent to the male connector and is formed with the first guide grooves that are in one-to-one correspondence with the female ports. The male terminal can be inserted into the corresponding female port through the corresponding first guide groove. The sidewall of the first guide groove is gradually tilted outward from the end adjacent to the female connector body toward the other end, so as to form a first guide angle that provides a guiding function for the male terminal. In this manner, even if the male terminal is tilted slightly, the male terminal can still be directed into the female port under the guidance of the first guide groove. After the anti-misalignment plate and the female connector body are separately molded and then assembled, the size of the first guide groove is not interfered with by a molding groove on the female connector body. Consequently, one end of the first guide groove adjacent to the male connector body can have a large size, enlarging the guiding range of the female connector for the male terminals and improving the tolerance for a tilted male terminal. The tilted male terminal can be guided into a corresponding female port, providing a certain corrective effect. This can prevent the male terminals from being tilted, improve the success rate of mating and assembly efficiency between the female connector and the male connector, reduce the maintenance rate of the male connector, and ensure the compatibility with the existing male connectors without modifying the structure of the male connector.

### BRIEF DESCRIPTION OF DRAWINGS

FIG. 1 is a view illustrating the structure of a female connector according to the present application.

FIG. 2 is an exploded view of a female connector according to the present application.

FIG. 3 is an enlarged view of part A in FIG. 2.

FIG. 4 is a view illustrating the structure of a male connector according to the present application.

FIG. 5 is a view illustrating the internal structure of a male connector according to the present application.

FIG. 6 is a view illustrating the assembly of a male terminal and a female connector according to the present application.

### Reference list

1 female connector

11 female connector body

12 anti-misalignment plate

121 first guide groove

122 first receiving groove

13 female port

131 second receiving groove

132 second guide groove

133 third receiving groove

14 snap block

141 guide surface

15 snap

16 limiting portion

17 snap-receiving groove

18 molding groove

2 male connector

21 male connector body

22 male terminal

23 slot

### DETAILED DESCRIPTION

The present application is further described below in detail in conjunction with the drawings and embodiments. It is to be understood that the embodiments described herein are intended to illustrate and not to limit the present application. Additionally, it is to be noted that for ease of description, only part, not all, of structures related to the present application are illustrated in the drawings.

In the description of the present application, terms "joined", "connected", and "secured" are to be understood in a broad sense unless otherwise expressly specified and limited. For example, the term "connected" may refer to "securely connected", "detachably connected", or "integrated", may refer to "mechanically connected" or "electrically connected", or may refer to "connected directly", "connected indirectly through an intermediary", "connected inside two elements", or "an interaction relationship between two elements". For those of ordinary skill in the art, specific meanings of the preceding terms in the present application may be understood based on specific situations.

In the present application, unless otherwise expressly specified and limited, when a first feature is described as "on" or "below" a second feature, the first feature and the second feature may be in direct contact or be in contact via another feature between the two features instead of being in direct contact. Moreover, when the first feature is described as "on", "above", or "over" the second feature, the first feature is right on, above, or over the second feature, the first feature is obliquely on, above, or over the second feature, or the first feature is simply at a higher level than the second feature. When the first feature is described as "under", "below", or "underneath" the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as "upper", "lower", and "right" are based on the drawings. These orientations or position relations are intended only to facilitate description and simplify operations and not to indicate or imply that a referred device or element must have such particular orientations or must be configured or operated in such particular orientations. Thus, these orientations or position relations are not to be construed as limiting the present application. Additionally, terms "first" and "second" are used for distinguishing between descriptions and have no special meanings.

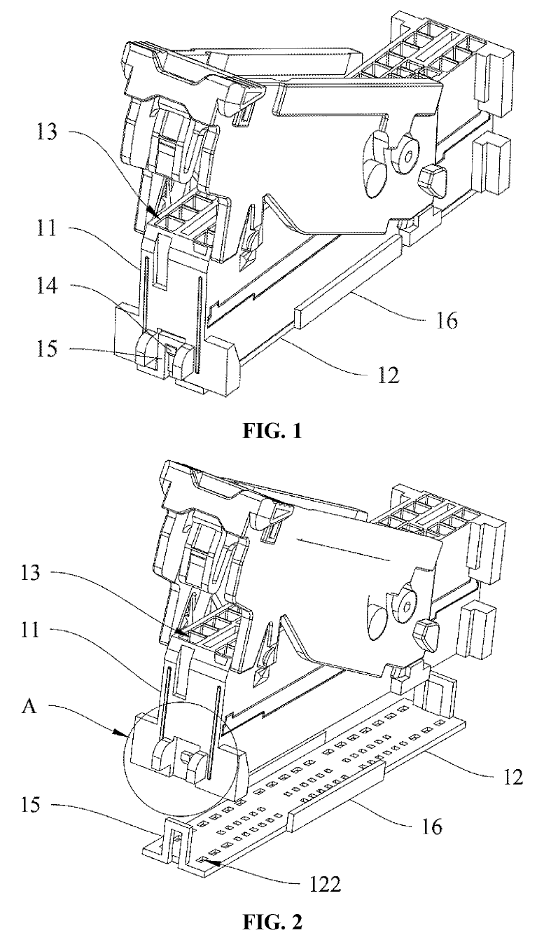

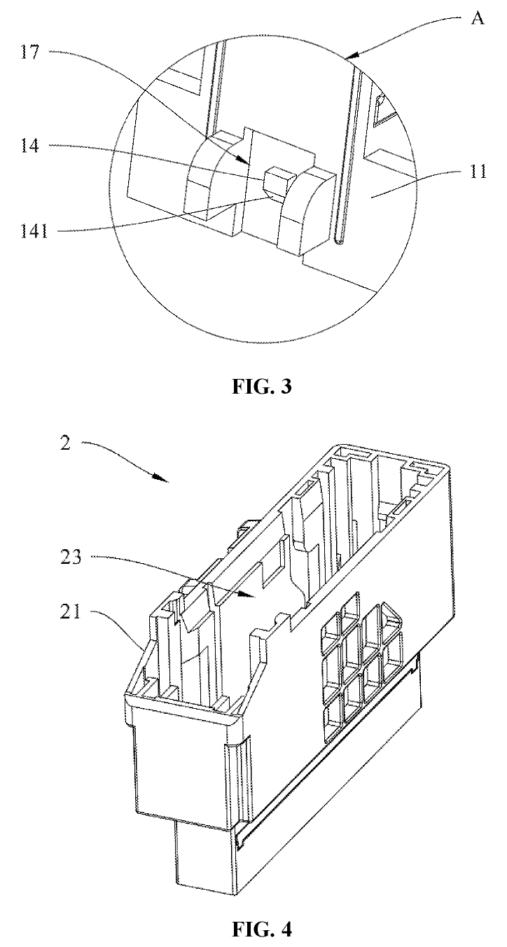

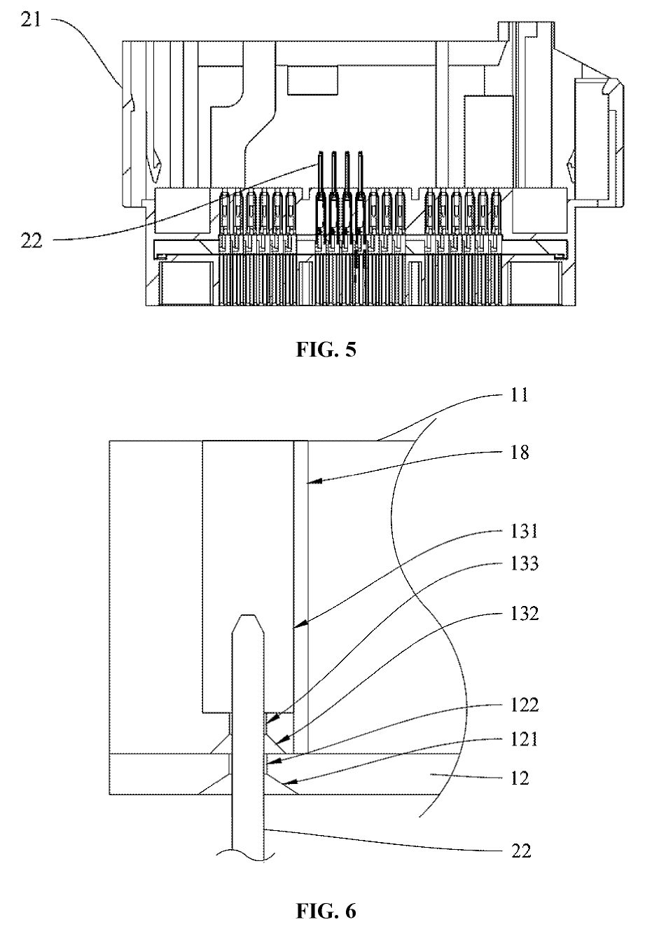

As shown in FIGS. 1 to 6, this embodiment provides a female connector 1. The female connector 1 can mate with a male connector 2, and the male connector 2 includes a male connector body 21 and multiple male terminals 22. The male connector body 21 is formed with a slot 23, and the multiple male terminals 22 are spaced apart and are erected at the bottom of the slot 23. The female connector 1 includes a female connector body 11 and an anti-misalignment plate 12. The female connector body 11 can mate with the slot 23 and is provided with female ports 13 that are in one-to-one correspondence with the male terminals 22. The anti-misalignment plate 12 is mounted at one end of the female connector body 11 adjacent to the male connector 2 and is formed with first guide grooves 121 that are in one-to-one correspondence with the female ports 13. A male terminal 22 can be inserted into a corresponding female port 13 through a corresponding first guide groove 121. A sidewall of the first guide groove 121 is gradually tilted outward from one end adjacent to the female connector body 11 toward the other end, so as to form a first guide angle that provides a guiding function for the male terminal 22. In this manner, even if the male terminal 22 is tilted slightly, the male terminal 22 can still be directed into the female port 13 under the guidance of the first guide groove 121.

As shown in FIG. 6, it is to be noted that, due to molding requirements of the female connector body 11, the female connector body 11 is further provided with a molding groove 18 that communicates with the female port 13. The presence of the molding groove 18 restricts the size of one end of the female port 13 adjacent to the male connector body 21, causing one end of an existing female port 13 adjacent to the male connector body 21 to have a small size. This makes it difficult for the existing female port 13 to accurately mate with the male terminal 22, resulting in poor insertion between the male connector 2 and the female connector 1. In this embodiment, after the anti-misalignment plate 12 and the female connector body 11 are separately molded and then assembled, the size of the first guide groove 121 on the anti-misalignment plate 12 is not interfered with by the molding groove 18, causing the cross-sectional area of one end of the first guide groove 121 adjacent to the male connector body 21 to be larger than that of one end of the corresponding female port 13 adjacent to the anti-misalignment plate 12. This can enlarge the guiding range of the female connector 1 for the male terminals 22 and improve the tolerance for a tilted male terminal 22. The tilted male terminal 22 can be guided into a corresponding female port 13, providing a certain corrective effect. This can prevent the male terminals 22 from being tilted, improve the success rate of mating between the female connector 1 and the male connector 2 and thereby improve the assembly efficiency of the female connector 1 and the male connector 2, reduce the maintenance rate of the male connector 2, and ensure compatibility with existing male connectors 2 without modifying the structure of the male connector 2.

Further, a sidewall of one end of the first guide groove 121 adjacent to the female connector body 11 extends along a height direction of the first guide groove 121 to form a first receiving groove 122, so as to avoid sharp corners within the anti-misalignment plate 12 that could cause stress concentration. This can improve the structural strength of the anti-misalignment plate 12, prolong the service life of the anti-misalignment plate 12, and prevent the sharp corners from damaging the surface of the male terminal 22.

In this embodiment, the anti-misalignment plate 12 is snap-fitted to the female connector body 11. The snap-fit connection can facilitate mounting and stably connect the anti-misalignment plate 12 to the female connector body 11, which helps improve the assembly efficiency and ensures the quality of the female connector 1. In other embodiments, the connection manner between the anti-misalignment plate 12 and the female connector body 11 includes, but is not limited to, adhesion, threaded connection, or insertion connection, which is not limited herein.

As shown in FIGS. 1 to 3, specifically, two ends of the female connector body 11 along a length direction of the female connector body 11 and/or two sides of the female connector body 11 along a width direction of the female connector body 11 are provided with snap blocks 14, respectively, the anti-misalignment plate 12 is provided with snaps 15 that are in one-to-one correspondence with the snap blocks 14, and the snaps 15 are configured to snap-fit with the snap blocks 14, respectively. In this manner, the anti-misalignment plate 12 is configured to snap-fit with the female connector body 11.

Furthermore, the anti-misalignment plate 12 is provided with limiting portions 16, and when the anti-misalignment plate 12 is snap-fitted to the female connector body 11, the female connector body 11 is clamped between the limiting portions 16, which can help further enhance the stability of the connection between the anti-misalignment plate 12 and the female connector body 11.

In this embodiment, the snap blocks 14 are provided at the two ends of the female connector body 11 along the length direction of the female connector body 11, respectively, and a distribution direction of the limiting portions 16 is perpendicular to a distribution direction of the snaps 15, that is, the limiting portions 16 are provided on two sides of the anti-misalignment plate 12 along a width direction of the anti-misalignment plate 12, respectively. It is to be readily understood that the shape of the anti-misalignment plate 12 matches the end surface of the female connector body 11. The anti-misalignment plate 12 has an elongated structure, and two ends of the anti-misalignment plate 12 in a length direction are snap-fitted to the female connector body 11, which can effectively prevent displacement of the anti-misalignment plate 12. The limiting portions 16 are provided on the two sides of the anti-misalignment plate 12 along the width direction of the anti-misalignment plate 12, respectively, and the limiting portions 16 clamp the female connector body 11 along the width direction of the female connector body 11. This can reduce the material usage of the anti-misalignment plate 12 and simplify the structure of the anti-misalignment plate 12 on the basis of ensuring the stable connection between the anti-misalignment plate 12 and the female connector body 11, thereby helping reduce production costs.

To facilitate the snap-fit between a snap 15 and a corresponding snap block 14, a lower end of the snap block 14 is provided with a guide surface 141. The guide surface 141 is gradually tilted upward in a direction away from the female connector body 11. During the snap-fitting process between the anti-misalignment plate 12 and the female connector body 11, the snap 15 can slide along the guide surface 141, causing the snap 15 to deform in the direction away from the female connector body 11, until an upper end of the snap 15 passes over the snap block 14. The restoring force of the material then brings the snap 15 toward the female connector body 11 to complete the snap-fit with the snap block 14. The provision of the guide surface 141 can help improve the convenience of the snap-fit between the anti-misalignment plate 12 and the female connector body 11 and reduce the labor intensity for assembly workers.

Further, the female connector body 11 is formed with snap-receiving grooves 17 that are in one-to-one correspondence with the snap blocks 14, the snap blocks 14 are disposed within the snap-receiving grooves 17, respectively, and the snap-receiving grooves 17 are configured to accommodate the snaps 15, respectively. In this manner, the snaps 15 can be embedded into the surface of the female connector body 11, thereby preventing interference with the internal structure of the male connector body 21.

With continued reference to FIG. 6, the female port 13 includes a second receiving groove 131 and a second guide groove 132, the second guide groove 132 communicates with one end of the second receiving groove 131 adjacent to the anti-misalignment plate 12, and a sidewall of the second guide groove 132 is gradually tilted outward from one end adjacent to the second receiving groove 131 toward the other end to form a second guide angle. In this manner, after a top end of the male terminal 22 passes through the first guide groove 121, the second guide groove 132 can provide guidance for the male terminal 22, thereby ensuring that the male terminal 22 can be accurately inserted into the female port 13.

A sidewall of one end of the second guide groove 132 adjacent to the second receiving groove 131 extends along a height direction of the second guide groove 132 to form a third receiving groove 133, and the third receiving groove 133 communicates with the second guide groove 132 and the second receiving groove 131, so as to avoid sharp corners within the female connector body 11 that could cause stress concentration. This can improve the structural strength of the female connector body 11, prolong the service life of the female connector body 11, and prevent the sharp corners from damaging the surface of the male terminal 22.

Additionally, this embodiment further provides a connector device. The connector device includes a male connector 2 and the female connector 1 of any one of the preceding embodiments. The male connector 2 includes the male connector body 21 and the multiple male terminals 22, the male connector body 21 is formed with the slot 23, and the multiple male terminals 22 are spaced apart and are erected at the bottom of the slot 23. The female connector body 11 can mate with the slot 23, and the male terminal 22 can be inserted into the corresponding female port 13 through the corresponding first guide groove 121. By applying the preceding female connector 1, the male terminals 22 can be prevented from being tilted, thereby improving the success rate of mating and assembly efficiency between the female connector 1 and the male connector 2, reducing the maintenance rate of the male connector 2, and enhancing the product quality of the connector device.

Apparently, the preceding embodiments of the present application are examples to clearly describe the present application and are not intended to limit implementations of the present application. Those of ordinary skill in the art can make various apparent modifications, adaptations, and substitutions without departing from the scope of the present application. All embodiments do not need to be and cannot be exhausted herein. Any modification, equivalent substitution, and improvement that are made within the spirit and principle of the present application fall within the scope of the claims of the present application.

What is claimed is:

1. A female connector, configured to mate with a male connector, wherein the male connector comprises a male connector body and a plurality of male terminals, the male connector body is formed with a slot, and the plurality of male terminals are spaced apart and are erected at a bottom of the slot; and wherein the female connector comprises a female connector body and an anti-misalignment plate, the female connector body is configured to mate with the slot, and the female connector body is provided with a plurality of female ports that are in one-to-one correspondence with the plurality of male terminals; the anti-misalignment plate is mounted at one end of the female connector body adjacent to the male connector, and the anti-misalignment plate is formed with a plurality of first guide grooves that are in one-to-one correspondence with the plurality of female ports, and among the plurality of male terminals, the plurality of first guide grooves, and the plurality of female ports, a male terminal is insertable into a corresponding female port through a corresponding first guide groove; and
wherein a sidewall of the first guide groove is gradually tilted outward from one end adjacent to the female connector body toward the other end.

2. The female connector of claim 1, wherein a sidewall of one end of the first guide groove adjacent to the female connector body extends along a height direction of the first guide groove to form a first receiving groove.

3. The female connector of claim 1, wherein the anti-misalignment plate is snap-fitted to the female connector body.

4. The female connector of claim 3, wherein two ends of the female connector body along a length direction of the female connector body and/or two sides of the female connector body along a width direction of the female connector body are provided with snap blocks, respectively, the anti-misalignment plate is provided with snaps that are in one-to-one correspondence with the snap blocks, and the snaps are configured to snap-fit with the snap blocks, respectively.

5. The female connector of claim 4, wherein the anti-misalignment plate is provided with limiting portions, and when the anti-misalignment plate is snap-fitted to the female connector body, the female connector body is clamped between the limiting portions.

6. The female connector of claim 4, wherein among the snap blocks, a lower end of a snap block is provided with a guide surface, and the guide surface is gradually tilted upward in a direction away from the female connector body.

7. The female connector of claim 4, wherein the female connector body is formed with snap-receiving grooves that are in one-to-one correspondence with the snap blocks, the snap blocks are disposed within the snap-receiving grooves, respectively, and the snap-receiving grooves are configured to accommodate the snaps, respectively.

8. The female connector of claim 1, wherein the female port comprises a second receiving groove and a second guide groove, the second guide groove communicates with one end of the second receiving groove adjacent to the anti-misalignment plate, and a sidewall of the second guide groove is gradually tilted outward from one end adjacent to the second receiving groove toward the other end.

9. The female connector of claim 8, wherein a sidewall of one end of the second guide groove adjacent to the second receiving groove extends along a height direction of the second guide groove to form a third receiving groove, and the third receiving groove communicates with the second guide groove and the second receiving groove.

10. A connector device, comprising a male connector and a female connector of claim 1, wherein the male connector comprises a male connector body and a plurality of male terminals, the male connector body is formed with a slot, and the plurality of male terminals are spaced apart and are erected at a bottom of the slot; and wherein the female connector comprises a female connector body and an anti-misalignment plate, the female connector body is configured to mate with the slot, and the female connector body is provided with a plurality of female ports that are in one-to-one correspondence with the plurality of male terminals; the anti-misalignment plate is mounted at one end of the female connector body adjacent to the male connector, and the anti-misalignment plate is formed with a plurality of first guide grooves that are in one-to-one correspondence with the plurality of female ports, and among the plurality of male terminals, the plurality of first guide grooves, and the plurality of female ports, a male terminal is insertable into a corresponding female port through a corresponding first guide groove; and
wherein a sidewall of the first guide groove is gradually tilted outward from one end adjacent to the female connector body toward the other end.

11. The connector device of claim 10, wherein a sidewall of one end of the first guide groove adjacent to the female connector body extends along a height direction of the first guide groove to form a first receiving groove.

12. The connector device of claim 10, wherein the anti-misalignment plate is snap-fitted to the female connector body.

13. The connector device of claim 12, wherein two ends of the female connector body along a length direction of the female connector body and/or two sides of the female connector body along a width direction of the female connector body are provided with snap blocks, respectively, the anti-misalignment plate is provided with snaps that are in one-to-one correspondence with the snap blocks, and the snaps are configured to snap-fit with the snap blocks, respectively.

14. The connector device of claim 13, wherein the anti-misalignment plate is provided with limiting portions, and when the anti-misalignment plate is snap-fitted to the female connector body, the female connector body is clamped between the limiting portions.

15. The connector device of claim 13, wherein among the snap blocks, a lower end of a snap block is provided with a guide surface, and the guide surface is gradually tilted upward in a direction away from the female connector body.

16. The connector device of claim 13, wherein the female connector body is formed with snap-receiving grooves that are in one-to-one correspondence with the snap blocks, the snap blocks are disposed within the snap-receiving grooves, respectively, and the snap-receiving grooves are configured to accommodate the snaps, respectively.

17. The connector device of claim 1, wherein the female port comprises a second receiving groove and a second guide groove, the second guide groove communicates with one end of the second receiving groove adjacent to the anti-misalignment plate, and a sidewall of the second guide groove is gradually tilted outward from one end adjacent to the second receiving groove toward the other end.

18. The connector device of claim 17, wherein a sidewall of one end of the second guide groove adjacent to the second receiving groove extends along a height direction of the second guide groove to form a third receiving groove, and the third receiving groove communicates with the second guide groove and the second receiving groove.
